(19) United States
(12) Patent Application Publication
(10) Pub. No.: US 2016/0085513 A1
(43) Pub. Date: Mar. 24, 2016

(54) Loading Code in Self-Contained Applications

(71) Applicant: MICROSOFT CORPORATION, Redmond, WA (US)

(72) Inventors: Jeremy Christopher Dorfman, Waltham, MA (US); James M. H. G. Oakley, Watertown, MA (US)

(21) Appl. No.: 14/490,922

(22) Filed: Sep. 19, 2014

(51) Int. Cl. G06F 9/44

(52) U.S. Cl. CPC G06F 8/34; G06F 8/70

(57) ABSTRACT

Updating application functionality. A method includes, importing from a management entity, a set of code into an application. The set of code provides a certain set of functions and/or functionality to the application. Based on the imported set of code, the method includes providing the certain set of functions and/or functionality. At a later time, as a result of the management entity providing an updated set of code, the method includes importing the updated set of code into the application, where the updated set of code provides a different set of functions and/or functionality to the application. Based on the imported updated set of code, the method includes providing a different set of functions and/or functionality.

### BACKGROUND

### Background and Relevant Art

Computers and computing systems have affected nearly every aspect of modern living. Computers are generally involved in work, recreation, healthcare, transportation, entertainment, household management, etc.

On some platforms, such as the Android platform available from Google Corporation of Mountain View, Calif., applications are generally self-contained, i.e. they have no external dependencies. However, this can pose a problem for users of such devices that use certain applications. In particular, certain applications or groups of applications may be implemented using a provider's SDK. For self-contained applications, whenever the SDK is revised, all applications using the SDK will need to be updated to interact properly with the SDK.

The SDK may be revised as part of policy enforcement. For example, users may use devices to access company resources. Any devices and/or application used to access company resources may be required to comply with some policy that the company wishes to enforce. For example, a company may wish to enforce certain password requirement, data encryption requirements, and/or data usage restrictions. As the policy or the ability to implement new policy features changes, it may be necessary to update the SDK to reflect the changed policy. Traditionally, this has required the applications implemented using the SDK to be updated by replacing the applications with new versions of the applications.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for updating application functionality. The method includes, importing from a management entity, a set of code into an application. The set of code provides a certain set of functions and/or functionality to the application. Based on the imported set of code, the method includes providing the certain set of functions and/or functionality. At a later time, as a result of the management entity providing an updated set of code, the method includes importing the updated set of code into the application, where the updated set of code provides a different set of functions and/or functionality to the application. Based on the imported updated set of code, the method includes providing a different set of functions and/or functionality.

Another embodiment includes a device configured to update application functionality on the device. The device includes an in-app SDK. An application is implemented with the in app SDK. The device includes a management entity. An out-of-app library is implemented in the management entity. The in-app SDK is configured to load code from the out-of-app library such that functionality of the application can be updated by changing code in the out-of-app library rather than updating the application itself.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a device having an application that can have its functionality updated by loading out-of-app code; and

FIG. 2 illustrates a method of updating application functionality.

### DETAILED DESCRIPTION

Embodiments herein can allow functionality of an application to be updated by updating portions of the application code without needing to update and replace the entire application. This can be accomplished by loading application code into the application from a management entity at start-up or by pausing the application at a rehydrateable point in execution, replacing the code, and rehydrating the application.

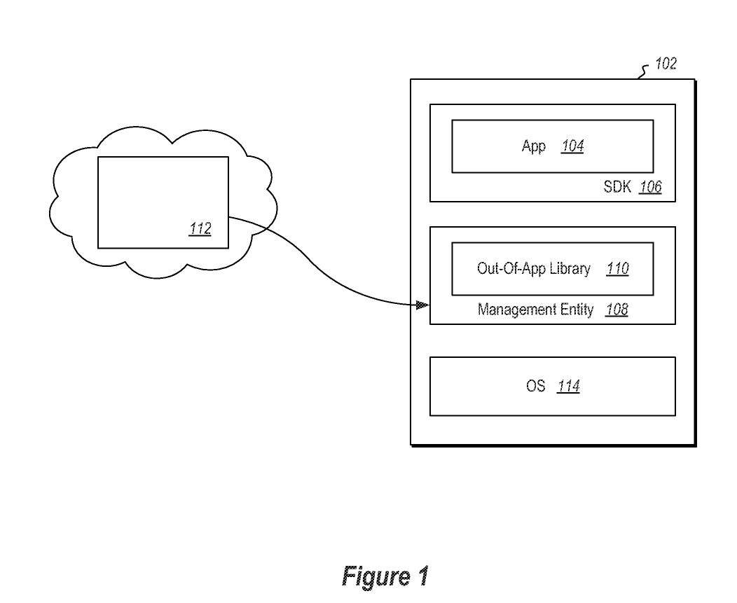

Referring now to FIG. 1, some embodiments can be implemented using the following components. FIG. 1 illustrates a device 102. The device 102 has an enlightened application (hereinafter “application”) 104. The application 104 may be any appropriate applications, such as an email client, word processing application, database client, or virtually any other appropriate application.

The device 102 also has an in-app SDK 106. The application 104 is built with the SDK 106. As will be illustrated in more detail below, the SDK 106 contains enough code to load the out-of-app library or to function without it.

The device 102 has a management entity 108. The management entity may be an application that helps users to find applications available from an organization to be installed on the device 102. In particular, the organization can use the management entity to ensure that apps comply with appropriate policy for the organization. The management entity 108 can be used for updating applications or otherwise managing applications provided by the organization. The management entity 108 may be, for example, Company Portal available from Microsoft Corporation of Redmond, Wash.

The management entity 108 hosts an out-of-app library 110. The out-of-app library 110 contains code. The code may be obtained from a management service 112 that interacts with the management entity 108. In some embodiments, the management service may be an Intune service available from Microsoft Corporation of Redmond, Wash.

The following illustrates now an illustrative flow. During the initialization of the application 104, the in-app SDK 106 looks for the management entity 108. If the management entity 108 is found and passes certain security checks, such as matching a known cryptographic signature for the management entity 108, out-of-app components from the out-of-app library 110 are loaded into the application 104. Otherwise, the code paths in the application 104 that require the out-of-app components from the out-of-app library 110 are disabled and in-app code is used instead. Thus, for example, the application 104 may include in-app code that has parallel functionality to code in the out-of-app library that can be used in place of code in the out-of-app library 110, such as for example, when the management entity 108 does not pass validation.

If the out-of-app library 110 was loaded successfully, a mechanism, such as a reflection-based marshalling mechanism, is used to provide a forward-compatible interface between the in-app SDK 106 and the out-of-app library 110. The code can then become active and interpose between the application 104 and the operating system 114, applying application management policies as necessary based on the management entity's configuration.

Notably, this functionality can be used to change functionality provided by an application. Thus, for example, new functionality can be added to an application using the techniques described herein. Alternatively or additionally, functionality can be removed from an application using the techniques described herein.

While in the example illustrated above, the code is inserted at application start-up, it should be appreciated that the code can be inserted at alternate times in alternate examples. In particular, in some embodiments, the application can be stopped while running, the state of the application can be saved, the code can be added to the application, and the application can be resumed with the new code and the saved state.

For example, embodiments may stop all threads running within an application while the application process remains running. This could be VM threads or native threads. When stopping all threads, consideration is given to stopping the threads at a rehydrateable location. A rehydrateable location is one where state of the application can be persisted and where important state will not be lost by the process of dehydrating and rehydrating the application. Thus, embodiments prevent overwriting of important information.

While the threads are stopped, a new process is started which redefines functions for the application. Thus, code can be loaded into the application.

Once the functions have been redefined, embodiments rehydrate all of the stopped threads. Thus, the new code is loaded into the application and new functionality can be implemented for the application. In this way, the application can be updated in a transparent fashion where the application did not need to be completely restarted including discarding any state existing due to previous execution of application functions. In some embodiments, adding new functionality particular, the user may experience virtually no disruption in the application's running processes and state, but rather only knows the application has been updated by virtue of the changed functionality.

Embodiments illustrated herein may exhibit one or more useful characteristics. For example, in some embodiments, the code loading approach illustrated herein can mitigate the deficiencies in the naïve framework approach by allowing new functionality to be enabled orthogonally from the state of the enlightened application. Alternatively or additionally, the in-app code may require minimal participation from the application. Alternatively or additionally, the in-app code can exist without the out-of-app components on the device. Alternatively or additionally, the out-of-app code can be updated and modified separately from the in-app component. Alternatively or additionally, the out-of-app component can be securely loaded by using techniques such as cryptographic signing. Alternatively or additionally, the out-of-app components can be controlled by a separate application (such as the management entity 108) to apply policy.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

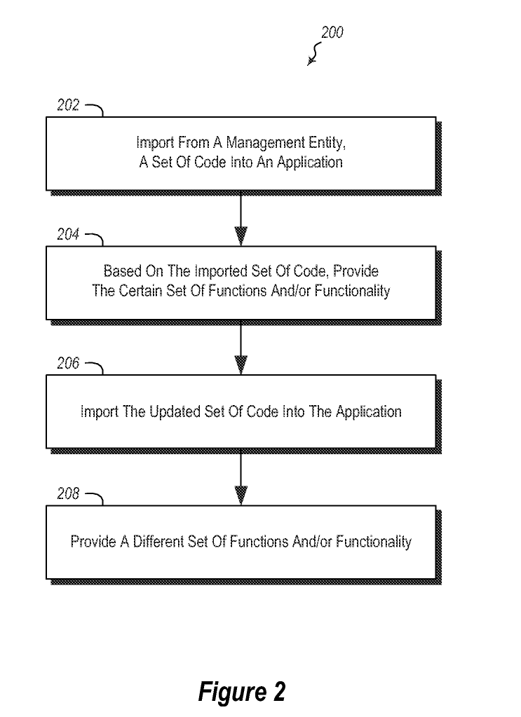

Referring now to FIG. 2, a method 200 is illustrated. The method may be practiced in a computing environment. The method includes acts for updating application functionality. The method includes importing from a management entity, a set of code into an application (act 202). The set of code provides a certain set of functions and/or functionality to the application. For example, the management service may provide policy enforcement code to an out-of-app library 110 that can be imported into the application 104.

The method 200 further includes, based on the imported set of code, providing the certain set of functions and/or functionality (act 204). In the example illustrated, the application 104 will provide functionality as enabled by the code.

At a later time, as a result of the management entity providing an updated set of code, the method 200 further includes importing the updated set of code into the application (act 206). The updated set of code provides a different set of functions and/or functionality to the application. Thus, for example, at a later time, the management service 112 may provide different code to the out-of-app library 110. The different code may be loaded into the application 104.

Based on the imported updated set of code, the method 200 further includes providing a different set of functions and/or functionality (act 208). Thus, for example, the different functionality based on the new code may be provided by the application 104.

The method 200 may be practiced where importing occurs as part of start-up of the application. Thus, for example, every time the application 104 is started, an attempt to load code from the out-of-app library 110 may be made.

In an alternative embodiment, the method 200 may be practiced where importing occurs in a continuation of application execution. Thus, rather than the application being shut down and all state from the running application being discarded, the application can be suspended, state can be preserved, code can be imported, and the application resumed. In one such example, the method 300 may include stopping all threads running within an application. This can be virtual machine threads, or native threads. Stopping all threads includes stopping the threads at a rehydrateable location. This is a point in the execution where rehydration of the application will not cause important state (including important data) to be overwritten. A new process is started (such as by the SDK 106) for the application which redefines functions for the application. All of the stopped threads are rehydrated once the functions have been redefined.

The method 200 may be practiced where sets of code imported into the application are imported from an out-of-app library in a management entity. In some such embodiments, the method may further include validating the management entity. For example, validating the management entity may include performing a cryptographic verification, such as verify a known cryptographic signature, of the management entity.

The method 200 may be practiced where providing a different set of function includes accessing managed versions of platform components opaquely to the application. Thus, application functionality can be updated with application participation and/or application permission.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or solid state devices, etc. which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of updating application functionality, the method comprising:
importing from a management entity, a set of code into an application, wherein the set of code provides a certain set of functions and/or functionality to the application;
based on the imported set of code, providing the certain set of functions and/or functionality;
at a later time, as a result of the management entity providing an updated set of code, importing the updated set of code into the application, where the updated set of code provides a different set of functions and/or functionality to the application; and
based on the imported updated set of code, providing a different set of functions and/or functionality.

2. The method of claim 1, wherein importing occurs as part of start-up of the application.

3. The method of claim 1, wherein importing occurs in a continuation of application execution.

4. The method of claim 3, wherein the method comprises:
stopping all threads running within an application while an application process remains running, wherein stopping all threads comprising stopping the threads at a rehydrateable location;
starting a new process which redefines functions for the application; and
rehydrating all of the stopped threads once the functions have been redefined.

5. The method of claim 1, wherein providing a different set of function comprises accessing managed versions of platform components opaquely to the application.

6. The method of claim 1, wherein sets of code imported into the application are imported from an out-of-app library in a management entity, the method further comprising validating the management entity

7. The method of claim 6, wherein validating the management entity comprises performing a cryptographic verification of the management entity.

8. In a computing environment, a device configured to update application functionality on the device, the device comprising:
an in-app SDK;
an application implemented with the in app SDK;
a management entity;
an out-of-app library implemented in the management entity; and
wherein the in-app SDK is configured to load code from the out-of-app library such that functionality of the application can be updated by changing code in the out-of-app library rather than updating the application itself.

9. The device of claim 8, wherein the application comprises in-app code that has parallel functionality to code in the out-of-app library that can be used in place of code in the out-of-app library.

10. The device of claim 8, wherein the in-app SDK is configured to validate the management entity.

11. The device of claim 9, wherein the in-app SDK is configured to validate the management entity by using cryptographic validation.

12. The device of claim 8, wherein the management entity is configured to connect to an external service to receive code.

13. The device of claim 8, wherein the in-app SDK is configured to load policy enforcement code from the out-of-app library.

14. The device of claim 8, wherein the in-app SDK is configured to load code by restarting the application.

15. The device of claim 8, wherein the in-app SDK is configured to load code as part of a continuation of the application, preserving state of the application while loading code.

16. One or more computer-readable storage media, wherein the one or more computer-readable media comprise computer-executable instructions that when executed by at least one of the one or more processors cause the following to be performed:
importing from a management entity, a set of code into an application, wherein the set of code provides a certain set of functions and/or functionality to the application;
based on the imported set of code, providing the certain set of functions and/or functionality;
at a later time, as a result of the management entity providing an updated set of code, importing the updated set of code into the application, where the updated set of code provides a different set of functions and/or functionality to the application; and
based on the imported updated set of code, providing a different set of functions and/or functionality.

17. The one or more computer-readable storage media of claim 16, wherein importing occurs as part of start-up of the application.

18. The one or more computer-readable storage media of claim 16, wherein importing occurs in a continuation of application execution.

19. The one or more computer-readable storage media of claim 17, wherein the method comprises:
stopping all threads running within an application while an application process remains running, wherein stopping all threads comprising stopping the threads at a rehydrateable location;
starting a new process which redefines functions for the application; and
rehydrating all of the stopped threads once the functions have been redefined.

20. The one or more computer-readable storage media of claim 16, wherein providing a different set of function comprises accessing managed versions of platform components opaquely to the application.
